(19) United States
(12) Patent Application Publication
(10) Pub. No.: US 2015/0064348 A1
(43) Pub. Date: Mar. 5, 2015

(54) Method for Manufacturing Optical Film

(71) Applicant: Nitto Denko Corporation, Osaka (JP)

(72) Inventors: Mitsuru SUZUKI, Osaka (JP); Takuya Mori, Osaka (JP); Daisuke Hayashi, Osaka (JP); Atsushi Muraoka, Osaka (JP); Nao Murakami, Osaka (JP)

(73) Assignee: Nitto Denko Corporation

(21) Appl. No.: 14/473,632

(22) Filed: Aug. 29, 2014

(30) Foreign Application Priority Data
Sep. 4, 2013 (JP) 2013-182999

(51) Int. Cl. G02B 1/04; G02B 5/30

(52) U.S. Cl. CPC G02B 1/04; G02B 5/3033
USPC 427/162

(57) ABSTRACT

The invention relates to a method for manufacturing an optical film. The method includes an unwinding step, a cleaning step and an application step. In the unwinding step, a long-band shaped flexible base having a first principal surface and a second principal surface is unwound from a continuous roll, and the base is continuously fed to a downstream side. In the cleaning step, a cleaning liquid is supplied between the second principal surface of the base and a cleaning roll, and the cleaning liquid is applied and spread over the base by the cleaning roll to clean the second principal surface of the base. Thereafter, in the application step, a resin solution is applied onto the first principal surface of the base and then the resin solution is dried.

### CROSS-REFERENCE TO RELATED APPLICATIONS

This Application claims priority to Japanese Patent Application No. JP 2011-182999; filed Sep. 4, 2013.

### BACKGROUND OF THE INVENTION

1. Field of the Invention

The invention relates to a method for manufacturing an optical film. Particularly, the invention relates to a method for forming a high-quality optical film with reduced defect by a solvent casting method.

2. Description of Related Art

Polymer films have excellent light permeability and flexibility and are capable of being lightened and thinned. Therefore, polymer films are widely used as optical films (e.g. retarders, polarizers and polarizer protecting films etc.) for formation of image display devices.

One of methods for manufacturing a polymer film is a solvent casting method. In the solvent casting, a resin solution (dope) obtained by dissolving a polymer in a solvent is applied onto a base, and the solvent is then removed by heating or the like. Since a film formed by the solvent casting method is excellent in uniformity of thickness and optical characteristics, the solvent casting method is widely used for formation of an optical film.

Solvent casting can be classified into methods using an endless base and using an ended base. The endless base includes an endless belt or drum roll composed of a metal such as stainless steel. The ended base includes a long-band shaped plastic film. When a film is formed on an endless base, the applied film (web) is peeled off from the base, and then subjected to processing such as drying and stretching. When the thickness of the film is small (e.g. 40 μm or less), the film peeled off from the base has a poor self-supporting characteristic and tends to be difficult to handle. Therefore, the endless base is not suitable for formation of a film having a small thickness.

On the other hand, when a film is formed on an ended base such as a plastic film, steps of drying, stretching and the like can be performed with the web closely attached on the base. Therefore, when an ended base is used, even a film having a small thickness and hence a poor self-supporting characteristic can be easily subjected to post-processing such as stretching without causing the problem of handling characteristics (for example, JP 2009-93074 A and JP 2007-331368 A).

Irrespective of whether an endless base or an ended base is used, there is the problem that foreign matters etc. stuck on the base are entrapped in the film during film formation, leading to generation of an optical defect. Methods for removing foreign matters on the base before casting or during casting have been proposed for preventing entrapment of foreign matters stuck on the base. Known methods for removing foreign matters include a method using ultrasonic air (JP 10-309553 A), a method spraying a cleaning gas (JP 2009-066982 A), a method rinsing a base (JP 2007-105662), and a method bringing a base into contact with an adhesive roll (JP 9-304621 A).

### BRIEF SUMMARY OF THE INVENTION

In recent years, performance requirements for optical films have been raised as displays have become widely available. At the same time, weight reduction and thickness reduction of displays have been increasingly required, leading to use of optical films having a smaller thickness as compared to conventional ones. Studies by the inventors have shown that when a film is formed on an ended base such as a resin film using a solvent casting method, a defect such as spot-shaped interference unevenness (hereinafter referred to as “spot-shaped unevenness” in some cases) may occur, and occurrence of spot-shaped unevenness tends to become prominent as the thickness of the film decreases. It has been found that in an area where spot-shaped unevenness occurs, the thickness of the film is decreased locally, and spot-shaped unevenness has been thought to be ascribable to foreign matters stuck on a casting roll.

Thus, the inventors have made an attempt to reduce spot-shaped unevenness by performing film formation by application of a solution while cleaning the roll surface by bringing a blade (scraper) into contact with a casting roll for removing foreign matters stuck on the casting roll. However, it has been unable to clearly confirm that the method of cleaning the roll surface has an effect of reducing spot-shaped unevenness.

In view of the above-mentioned problem, an object of the present invention is providing a high-quality optical film by reducing occurrence of a “spot-shaped unevenness” defect with the thickness decreased locally in formation of an optical film by solvent casting on a base.

It has been found that by performing in-line cleaning of the film application-side surface and the opposite-side surface (back surface) of a base after the base being unwound and before applying a dope thereon, spot-shaped unevenness is reduced. Further, it has been found that by performing wet cleaning with the back surface of the base and the roll brought into contact with each other with a cleaning liquid interposed therebetween, spot-shaped unevenness is considerably reduced.

The present invention relates to a method for manufacturing an optical film. In the method according to the present invention, a long-band shaped flexible base is unwound from a continuous roll, and continuously fed to the downstream side (unwinding step). The base has a first principal surface as a film application surface and a second principal surface as a back surface with respect to the film application surface. In the manufacturing method of the present invention, the second principal surface of the base is cleaned (cleaning step), and a resin solution is then applied onto the first principal surface of the base and then dried (application step) to obtain an optical film.

In the cleaning step, a cleaning liquid is supplied between the back surface of the base and a cleaning roll, and the cleaning liquid is applied and spread over the base by the cleaning roll to perform cleaning. The cleaning roll is preferably one having an asperity pattern on the surface, and particularly a cleaning roll in which a projection portion of the asperity pattern extends in non-parallel to the circumferential direction of the roll is preferably used. It is considered that in the present invention, wet cleaning is performed with a cleaning roll brought into contact with the back surface of a base with a cleaning liquid interposed therebetween, so that foreign matters stuck on the back surface of the base are removed to reduce spot-shaped unevenness.

Examples of the cleaning roll for use in the present invention include a gravure roll and a Meyer bar roll. As the cleaning liquid, a high-volatile liquid having a boiling point lower than that of water is preferably used.

According to the manufacturing method of the present invention, there is provided a high-quality optical film in which occurrence of a “spot-shaped unevenness” defect with the thickness of a film decreased locally is suppressed. Generally, spot-shaped unevenness becomes easier to occur as the thickness of a film formed on a base decreases, and particularly when the thickness is 40 μm or less, influences thereof tend to be serious. On the other hand, according to the manufacturing method of the present invention, occurrence of spot-shaped unevenness can be reduced even when the post-drying thickness of a film formed on a base is 40 μm or less.

### BRIEF DESCRIPTION OF THE SEVERAL VIEWS OF THE DRAWING

FIG. 1 is a schematic view showing one embodiment of a film formation apparatus.

FIG. 2 is a schematic plan view for illustrating surface pattern shape of a gravure roll.

FIG. 3A is a schematic plan view for illustrating surface pattern shape of a Meyer bar roll; and

FIG. 3B is a sectional view along B1-B2 line in FIG. 3A.

### DETAILED DESCRIPTION OF THE INVENTION

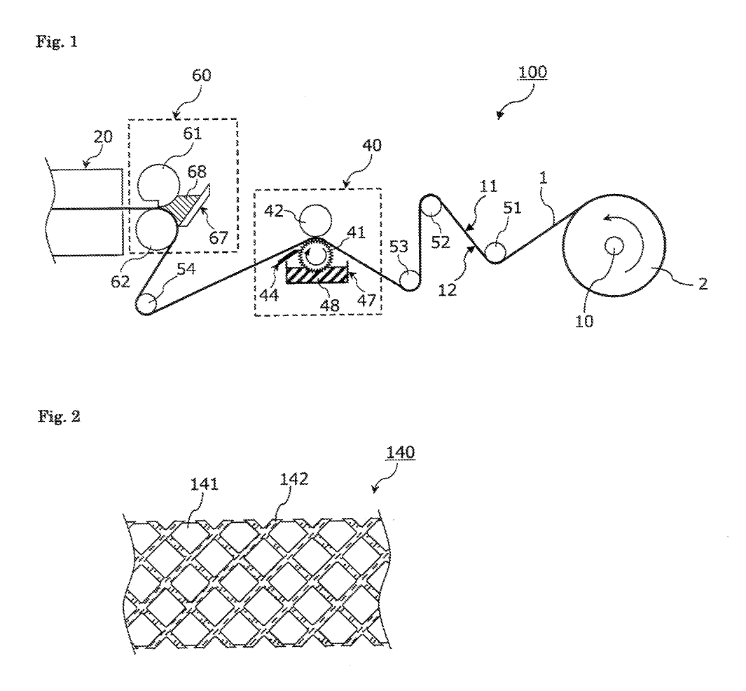

FIG. 1 is a schematic view showing one embodiment of a film formation apparatus to be used for manufacturing an optical film in the present invention. In the film formation apparatus 100 shown in FIG. 1, a continuous roll 2 of a long-band shaped base is set in an unwinding unit 10. The base 1 unwound from the continuous roll 2 is continuously feed from the unwinding unit 10 to the downstream side of the film formation apparatus, and conveyed via guide rollers 51, 52 and 53 to a cleaning unit 40 provided on the downstream side of the guide roller 53 (unwinding step). The back surface of the base 1 is cleaned in the cleaning unit 40 (cleaning step). The cleaned base 1 is further fed to the downstream side, and conveyed via a guide roller 54 to a film application unit 60, where film application is performed (application step).

Base

The base 1 should have flexibility, and one that is excellent in mechanical strength, heat stability, water barrier property, isotropy and so on is preferably used. The base has a first principal surface and a second principal surface, and an optical film is formed on the first principal surface. Hereinafter, the first principal surface is referred to as a “film application surface”, and the second principal surface, i.e. a surface opposite thereto, is referred to as a “back surface”.

As the base, a resin film, a metal foil, a paper, a cloth, a laminate thereof or the like is used. Particularly, a resin film is preferably used because it is excellent in surface smoothness and has reduced foreign matters generated from the base itself.

Examples of the resin material that forms the base film include polyesters such as polyethylene terephthalate and polyethylene naphthalate; cellulose-based polymers such as diacetyl cellulose and triacetyl cellulose; acryl-based polymers such as polymethyl methacrylate; styrene-based polymers such as polystyrene and acrylonitrile-styrene copolymers; polyolefins such as polyethylene, polypropylene and ethylene-propylene copolymers; cyclic polyolefins such as polynorbornene; amide-based polymers such as nylon and aromatic polyamides; polycarbonate; vinyl chloride; imide-based polymers; sulfone-based polymers; polyether sulfone; polyether ether ketone; polyphenylene sulfide; vinyl alcohol-based polymers; vinylidene chloride; and epoxy-based polymers. Among them, those that are not dissolved in a solvent during solvent casting are suitably used.

The base may be colorless and transparent, or may be colored or opaque. In the case where after a film is formed on the base, a laminate of the base and the film formed thereon is put into practical use as a laminated optical film, one that is transparent and has uniform optical characteristics is preferably used as the base. A surface of the base may be subjected to adhesion facilitating treatment, release treatment, antistatic treatment and antiblocking treatment etc. Transverse direction ends of the base may be subjected to embossing (knurling) etc. in order to prevent blocking, etc.

The thickness of the base is not particularly limited as long as the base has both a self-supporting property and flexibility. The thickness of the base is generally 20 μm to 200 μm, preferably 30 μm to 150 μm, more preferably 35 μm to 100 μm. When a film is formed on an ended base such as a long-band shaped film using a solvent casting method, a length in which continuous film formation is possible is limited because the length of the base is finite. Generally, the unwinding unit 10 and a winding unit (not shown) for winding the formed film define the upper limits of the weight and diameter of a continuous roll to be set thereon. Therefore, when the base has a small thickness, the continuous film formation length can be increased, leading to improvement of productivity. Therefore, the thickness of the base is preferably as small as possible within the bounds of not impairing film formability and handling characteristics.

On the other hand, studies by the inventors have shown that the number of occurrences of spot-shaped unevenness tends to increase when the base has a small thickness. In the present invention, in contrast, the back surface of the base is cleaned in advance of film application by a specific method described later, so that occurrence of spot-shaped unevenness is suppressed even when the base has a small thickness.

Cleaning Unit

Along the path-line of the base 1, the cleaning unit 40 is provided between the unwinding unit 10 and the film application unit 60. In the cleaning unit 40, wet cleaning is performed with the back surface 12 of the base 1 and a cleaning roll 41 brought into contact with each other with a cleaning liquid interposed therebetween. in the present invention, it is thought that when a cleaning liquid supplied between the cleaning roll and the base back surface is applied and spread over the base by the cleaning roll, a shear force is given to the interface between the cleaning liquid and the base to efficiently clean away foreign matters stuck on the base, so that spot-shaped unevenness is suppressed.

In the configuration shown in FIG. 1, the cleaning unit 40 includes backup roll 42 provided so as to be in contact with the film application surface 11 of the base 1, and the cleaning roll 41 provided so as to be in contact with the back surface 12 of the base 1. A cleaning liquid 47 is stored in a cleaning pan 48, and the cleaning liquid deposited on the cleaning roll 41 is guided to the back surface 12 of the base 1 while an excessive fraction thereof is scraped off by a doctor blade 44.

Cleaning Roll

As the cleaning roll 41, various kinds of rolls to be used for solution coating, such as a knife roll (comma roll), a kiss roll, a gravure roll and a Meyer bar roll, are used. The cleaning roll may be a rotating roll, or may be a non-rotating roll. When the cleaning roll is a rotating roll, the rotation direction may be either a normal direction or a reverse direction.

It is preferred that an asperity pattern is formed on the surface of the cleaning roll for enhancing base cleaning efficiency. Preferably, the asperity pattern on the surface of the cleaning roll is configured such that the projection portion extends in non-parallel to the circumferential direction of the roll. When the projection portion extending in non-parallel to the circumferential direction of the cleaning roll 41 is in contact with the base surface, foreign matters etc. stuck on the base tend to be more efficiently cleaned away to reduce generation of spot-shaped unevenness.

Examples of the roll having a projection portion extending in non-parallel to the circumferential direction include a gravure roll, a Meyer bar roll and an embossing roll. As the cleaning roll, a gravure roll and a Meyer bar roll are especially preferably used because a cleaning liquid can be applied and spread over the base back surface without damaging the base.

FIG. 2 is a plan view showing one example of an asperity pattern shape of the surface of a gravure roll. On the surface of a gravure roll 140, a recess portion (gravure groove) 141 and a projection portion 142 are formed in a pattern shape. It is considered that when a gravure roll is used as the cleaning roll, a liquid stored in the recess portion comes into contact with the base surface, and foreign matters stuck on the base surface are scraped of by coming into contact with the projection portion, leading to removal of foreign matters. FIG. 2 shows a tetragonal shape (square type) as the gravure pattern shape, but as long as the projection portion extends in an oblique direction, the shape of the gravure pattern is not particularly limited, and may be a rectangular shape, a polygonal shape such as a honeycomb type, or a linear shape such as an oblique line shape or a wavy line shape.

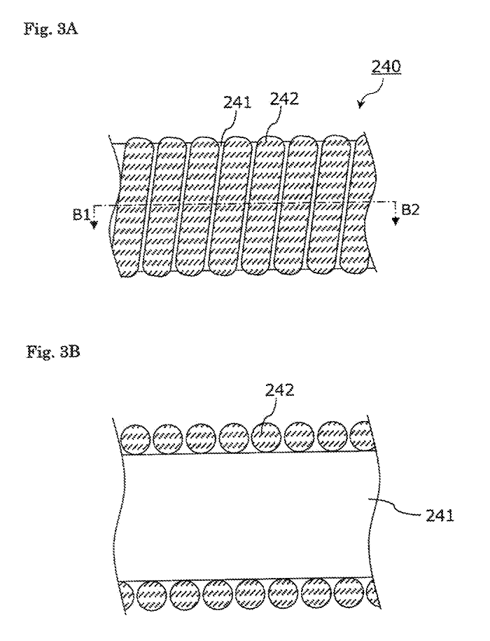

FIG. 3A is a plan view showing one example of an asperity pattern shape on the surface of a Meyer bar roll 240, and FIG. 3B is a sectional view taken along the line B1-B2. The Meyer bar roll is a roll in which a narrow line 242 such as a wire is wound around the surface of a roll body (cylinder) 241, so that a projection portion extending in a direction non-parallel to the circumferential direction is formed by the narrow line 242. It is considered that when a Meyer bar roll is used as the cleaning roll, a liquid stored in gaps between adjacent narrow lines 242 comes into contact with the base surface, and foreign matters stuck on the base surface are scraped off by coming into contact with the helically wound fine line 242, leading to removal of foreign matters. FIGS. 3A and 3B show a configuration in which one fine line 242 is wound around a cylinder, but the Meyer bar may have multiple fine lines wound around a cylinder. The fine line 242 may be wound without a break, or may be wound at a fixed interval. The distance between adjacent narrow lines is preferably equal to or smaller than the fine line.

The height of the projection portion on the surface of the cleaning roll is not particularly limited, but is preferably in a range of about 0.1 μm to 10 μm like the height of a projection portion of a general gravure, Meyer bar roll or the like. When the height of the projection portion is excessively small, the cleaning effect may be insufficient. On the other hand, when the height of the projection portion is excessively large, the spread thickness of the cleaning liquid increases, and therefore cleaning efficiency may be reduced or it may take a long time to dry the cleaning liquid, leading to a reduction in production efficiency.

Cleaning Liquid

In the cleaning step, a cleaning liquid is supplied between the cleaning roll 41 and the back surface 12 of the base 1. The cleaning roll 41 and the back surface 12 of the base 1 come into contact with each other, so that the cleaning liquid is applied and spread over the back surface of the base to perform cleaning. The cleaning liquid is not particularly limited as long as it is liquid and does not dissolve the base 1. As the cleaning liquid, water, an organic solvent, a mixture of water and an organic solvent, or the like may be used.

A low-boiling-point and high-volatility liquid is suitably used for efficiently performing in-line cleaning along the path-line extending from the unwinding unit 10 to the film application unit 60. Examples of the high-volatility liquid include alcohols such as methanol, ethanol and isopropyl alcohol; ketones such as acetone and methyl ethyl ketone; halogenated alkyls such as chloroform, dichloromethane and dichloroethane; and ethers such as diethyl ether, ethyl propyl ether and ethyl isopropyl ether. A mixture of these organic solvents, a mixture of these organic solvents and water, or the like can also be used. A surfactant, a hydrophilic organic compound or the like may be added in the cleaning liquid in order to improve cleaning power. Examples of the hydrophilic organic compound include organic compounds having a hydroxyl group, an amino group, an amide group, an imino group, an imide group, a nitro group, a cyano group, an isocyanate group, a carboxyl group, an ester group, an ether group, a carbonyl group, a sulfonic acid group, an SO group and the like.

Cleaning Method

The cleaning method is not particularly limited as long as it is a method in which a cleaning liquid supplied between the cleaning roll 41 and the back surface 12 of the base 1 is applied and spread over the base. The method for supplying a cleaning liquid between the cleaning roll and the base is not particularly limited. FIG. 1 shows a configuration in which the cleaning roll 41 is brought into direct contact with the cleaning liquid 47 in the cleaning pan 48 (direct gravure method). A method may be employed in Which another roll (offset roll) is brought into contact with the cleaning liquid in the cleaning pan, and the cleaning liquid deposited on the offset roll surface is transferred to the cleaning roll arranged so as to be in contact with the offset roll (offset gravure). The cleaning liquid can be supplied between the cleaning roll 41 and the back surface 12 of the base 1 by a method in which before the base 1 comes into contact with the cleaning roll 41, the cleaning liquid is applied to the back surface 12 of the base 1 using a slot die, a spray or the like, the base is made to run within the cleaning pan, or the cleaning liquid is deposited on the surface of the cleaning roll 41 using a spray or the like, besides the method in which the cleaning liquid is deposited on the surface of the cleaning roll 41.

The base 1 is continuously fed to the downstream side (left side in FIG. 1) while being in contact with the cleaning roll 41, and therefore the cleaning liquid supplied between the cleaning roll 41 and the base is necessarily applied and spread over the base surface. The cleaning roll 41 and the base 1 may be in direct contact with the back surface 12 of the base 1, or may have a gap therebetween. For example, the gap between the cleaning roll and the back surface of the base is preferably 0.1 μm to 10 μm. When the gap is excessively large, a shear force at an interface created when the roll and base come into contact with each other with the cleaning liquid interposed therebetween tends to decrease, leading to a reduction in cleaning efficiency. When the cleaning roll has an asperity pattern on the surface, the gap between the cleaning roll and the base can be adjusted to a desired range by the height of the projection portion on the roll surface as described above. When the cleaning roll does not have an asperity pattern on the surface, the gap can be adjusted by the relative positional relationship between the cleaning roll and the base.

FIG. 1 shows a configuration in which in the cleaning unit 40, the back surface 12 of the base 1 is in contact with the cleaning roll 41 and the film application surface 11 is in contact with the backup roll 42, but the backup roll in the cleaning unit 40 is not necessarily required as long as the path-line of the base is configured such that the back surface 12 of the base 1 and the cleaning roll 41 are in contact with each other with the cleaning liquid interposed therebetween. The film application surface 11 may be cleaned in parallel to cleaning of the back surface 12 of the base 1 by using a roll having an asperity pattern on the surface in place of the backup roll 42.

The base 1, the hack surface 12 of which is cleaned in the cleaning unit 40, is conveyed via the guide roller 54 and fed to the film application unit 60. The cleaning liquid deposited on the base surface may be dried while the base is fed from the cleaning unit 40 to the film application unit 60. The drying method is not particularly limited, and examples thereof include a method in which clean air is sprayed and a method in which the base is made to pass through the inside of a heating oven.

Film Application Unit

In the application unit 60, a dope 68 is applied and spread over the film application surface 11 of the base 1, and a film is formed in accordance with a usual method. FIG. 1 shows a knife roll coater. In this roll coater, the back surface 12 of the base 1 is brought into contact with the dope 68 in a liquid dam 67 while being in contact with the backup roll 62, and the dope is cut by a knife roll 61 to adjust the application thickness.

The application method in the film application unit 60 is not limited to knife roll coating, and various kinds of methods such as kiss roll coating, gravure coating, reverse coating, spray coating, Meyer bar coating, air knife coating, curtain coating, lip coating and die coating are used.

The dope 68 is a solution of a resin material (resin solution) for forming an optical film, and may contain additives such as a pigment, a leveling agent, a plasticizer, an ultraviolet absorber and a degradation inhibitor as necessary. The resin material for forming an optical film is preferably a transparent polymer, and for example, those described above as the resin material that forms a base film, etc. are suitably used. A plurality of resin materials may be used in mixture according to optical characteristics etc. of the intended optical film. The solid content and the viscosity of the dope are appropriately set according to a type and a molecular weight of the resin, a thickness of the optical film, an application method and so on.

The characteristics of the optical film often depend on a thickness. For example, the retardation value of an optical compensation film is represented by a product of a birefringence and a thickness. The absorbance of a polarizing plate etc. is represented by a product of an absorption coefficient and a thickness. Therefore, for ensuring that the characteristics of the Optical film are uniform, the thickness during application is preferably uniform. For ensuring that the thickness is uniform, it is preferred that an application is performed while the back surface 12 of the base 1 is supported by the backup roll 62 as shown FIG. 1.

On the other hand, if foreign matters exist between the backup roll 62 and the back surface 12 of the base 1, the film application surface 11 of the base 1 is convexly deformed by the pressing force of the foreign matters. When the dope is applied thereon, the application thickness of the deformed portion of the base may be locally reduced, leading to occurrence of spot-shaped unevenness. In contrast, in the present invention, it is thought that since the back surface 12 of the base 1 is cleaned in-line to remove stuck foreign matters, occurrence of spot-shaped unevenness is suppressed even when solvent casting is performed while the base is supported by the backup roll.

The application thickness is set so that the thickness after drying is, for example, about 1 μm to 200 μm depending on characteristics of the intended optical film, etc. Generally, occurrence of spot-shaped unevenness tends to become prominent when the thickness of the optical film after drying is 40 μm or less. On the other hand, in the present invention, by passing through the above-mentioned cleaning step, occurrence of spot-shaped unevenness is reduced even when the thickness of the optical film after drying is 40 μm or less. Therefore, the manufacturing method of the present invention is suitably used particularly in manufacture of an optical film having a small thickness. The manufacturing method of the present invention is particularly effective in suppression of spot-shaped unevenness when the thickness of the optical film after drying is 40 μm or less, and spot-shaped unevenness can be reduced, for example, even when the thickness of the optical film is 30 μm or less, 20 μm or less, 15 μm or less or 10 μm or less.

Step After Application

The coating of the dope applied on the film application surface 11 of the base 1 is fed into a drying furnace 20 along with the base 1, and a solvent is removed to form a film. The dried film may be wound directly while being closely attached to the base 1. The base and the film may be separately wound after being peeled from each other. The film peeled from the base can also be subjected to another step such as drying or stretching.

The film wound while being closely attached to the base may be put into practical use as an optical film integrally with the base. The film can also be subjected to another step such as stretching while being closely attached on the base. Thereafter, the film may be used as an optical film integrally with the base, or may be peeled off from the base and used as an optical film. The film may be transferred to another film base material etc., or another coating layer may be further applied onto the film.

The optical film of the present invention which is obtained as described above can be used as an optical film for image display devices because spot-shaped unevenness is reduced and there are few optical defects. Specific examples of the optical film for image display devices include optical compensation films such as retarders, polarizers and polarizer protecting films.

### EXAMPLES

The present invention will be described more in detail below by showing Examples, but the present invention is not intended to be limited to the following Examples.

### Example 1

Preparation of Dope

A polyimide (weight average molecular weight: 120,000) obtained by dehydrating a polycondensate of 2,2′-bis(3,4-dicarboxyphenyl)hexafluoropropane dianhydride (6FDA) and 2,2′-bis(trifluoromethyl)-4,4′-diaminobiphenyl (TFMB) was dissolved in methyl isobutyl ketone (MIBK) to prepare a polyimide solution (dope) having a solid content of 15% by weight.

Formation of Polyimide Film

A biaxially oriented polyethylene terephthalate film (manufactured by Mitsubishi Plastics, Inc., trade name: Diafoil T302) having a thickness of 75 μm was used as a base film. A continuous roll of the base film was set in an unwinding unit 10 of a film formation apparatus schematically shown in FIG. 1. The base film was unwound and continuously fed to run while a gravure roll was brought into contact with the back surface side of the base film with isopropyl alcohol as a cleaning liquid, thereby cleaning the back surface of the base. The dope was applied onto the application surface of the base after cleaning so as to have a thickness of 6 μm after drying, and the dope was dried at 150° C. The obtained polyimide film was wound along with the base.

### Example 2

Cleaning was performed in the same manner as in Example 1 except that cleaning was performed with a gravure roll brought into contact with not only the back surface side but also the application surface side of a base film with isopropyl alcohol as a cleaning liquid. That is, in Example 2, cleaning was performed with the gravure roll brought into contact with both the back surface and application surface of the base film. Thereafter, a dope was applied and dried in the same manner as in Example 1 to obtain a polyimide film.

### Examples 3 and 4

A Meyer bar roll was used in place of the gravure roll. Otherwise in the same manner as in Examples 1 and 2, cleaning was performed, and then a dope was applied and dried to obtain a polyimide film. That is, cleaning was performed with the Meyer bar roll brought into contact with the back surface of a base film in Example 3, and cleaning was performed with the Meyer bar roll brought into contact with both the surfaces of a base film in Example 4.

### Comparative Example 1

Either the back surface or the application surface of a base film was not cleaned, and a dope was applied and dried in the same manner as in Example 1 to obtain a polyimide film.

### Comparative Example 2

Cleaning was performed in the same manner as in Example 2 except that the back surface side of a base film was not cleaned, and only the application surface of the base film was cleaned with a gravure roll brought into contact therewith. Thereafter, a dope was applied and dried in the same manner as in Example 1 to obtain a polyimide film.

### Comparative Example 3

Cleaning was performed in the same manner as in Example 4 except that the back surface side of a base film was not cleaned, and only the application surface of the base film was cleaned with a gravure roll brought into contact therewith. Thereafter, a dope was applied and dried in the same manner as in Example 1 to obtain a polyimide film.

### Comparative Example 4

As in the case with Comparative Example 1, either the back surface or the application surface of a base film was not cleaned, and a dope was applied and dried in the same manner as in Example 1 to obtain a polyimide film. In Comparative Example 4, film formation was performed while a backup roll was constantly cleaned by bringing a scraper into contact with the backup roll that was in contact with the back surface of a base during application of a dope.

### Comparative Example 5

The guide roll coming into contact with the back surface of a base immediately before an application unit of a film formation apparatus was changed to an adhesive roll, and the back surface of the base was cleaned by contact with the adhesive roll. On the other hand, in Comparative Example 5, cleaning with a cleaning roll was not performed. Otherwise in the same manner as in Example 1, a dope was applied and dried in the same manner as in Example 1 to obtain a polyimide film.

### Comparative Example 6

The guide roll coming into contact with the application surface of a base immediately before an application unit of a film formation apparatus was changed to an adhesive roll, and the application surface of the base was cleaned by contact with the adhesive roll. On the other hand, in Comparative Example 6, cleaning with a cleaning roll was not performed. Otherwise in the same manner as in Example 1, a dope was applied and dried in the same manner as in Example 1 to obtain a polyimide film.

### Comparative Example 7

The guide rolls coming into contact with the back surface of a base and coming into contact with the application surface immediately before an application unit of a film formation apparatus were changed to adhesive rolls, and the back surface and the application surface of the base were cleaned by contact with the adhesive rolls. On the other hand, in Comparative Example 7, cleaning with a cleaning roll was not performed. Otherwise in the same manner as in Example 1, a dope was applied and dried in the same manner as in Example 1 to obtain a polyimide film.

### Comparative Example 8

In the same manner as in Example 1, the back surface side of a base film was cleaned with a gravure roll brought into contact therewith using isopropyl alcohol as a cleaning liquid. Thereafter, the base film was wound without applying a dope (off-line cleaning was performed). The wound base film after the off-line cleaning was set in the film formation apparatus again. Either the back surface or the application surface of the base film was not cleaned, and a dope was applied and dried to obtain a polyimide film.

### Comparative Example 9

Off-line cleaning of the back surface side of the base film was performed in the same manner as in Comparative Example 8 except that a Meyer bar roll was used in place of the gravure roll. The wound base film after the off-line cleaning was set in the film formation apparatus again. Either the back surface or the application surface of the base film was not cleaned, and a dope was applied and dried to obtain a polyimide film.

### Evaluation

The optical film composed of polyimide, which was obtained in each of the Examples and Comparative Examples was irradiated with white-color light from the polyimide film side in a dark room with the optical film still laminated with the base film, and presence/absence of areas with ring-shaped interference fringes generated in reflection light due to a change in thickness was visually checked. The number of areas with ring-shaped interference fringes generated in reflection light in a region of 1 m² was counted, and defined as a spot-shaped unevenness number. A list of cleaning condition sand spot-shaped unevenness numbers in the Examples and Comparative Examples is shown in Table 1.

TABLE 1

| | | Application | Back | spot-shaped |
|---|---|---|---|---|
| | Subject of cleaning | surface | surface | unevenness numbers |
| Example 1 | in-line base cleaning | — | gravure | 0 |
| Example 2 | in-line base cleaning | gravure | gravure | 0 |
| Example 3 | in-line base cleaning | — | Meyer bar | 0 |
| Example 4 | in-line base cleaning | Meyer bar | Meyer bar | 0 |
| Comparative | No cleaning performed | | | 50 |
| Example 1 | | | | |
| Comparative | in-line base cleaning | gravure | — | 35 |
| Example 2 | | | | |
| Comparative | in-line base cleaning | Meyer bar | — | 39 |
| Example 3 | | | | |
| Comparative | Backup roll cleaning | | | 42 |
| Example 4 | | | | |
| Comparative | in-line base cleaning | — | adhesive roll | 6 |
| Example 5 | | | | |
| Comparative | in-line base cleaning | adhesive roll | — | 38 |
| Example 6 | | | | |
| Comparative | in-line base cleaning | adhesive roll | adhesive roll | 7 |
| Example 7 | | | | |
| Comparative | off-line base cleaning | — | gravure | 40 |
| Example 8 | | | | |
| Comparative | off-line base cleaning | — | Meyer bar | 42 |
| Example 9 | | | | |

In comparative Examples 2 and 3, the application surface of the base material was cleaned, but there was no apparent change in spot-shaped unevenness number as compared with Comparative Example 1 in which cleaning was not performed. In Comparative Example 4 in which the backup roll was cleaned and Comparative Example 6 in which the application surface was cleaned with an adhesive roll, there was no apparent change in spot-shaped unevenness number.

In contrast, in Examples 1 to 4 and Comparative Examples 5 and 7 in which the back surface was cleaned in-line, the spot-shaped unevenness number was considerably reduced. On the other hand, in Comparative Examples 8 and 9 in which the back surface was cleaned off-line, there was no apparent change in spot-shaped unevenness number. From these results, it is apparent that the spot-shaped unevenness number is considerably reduced by performing in-line cleaning of the back surface of the base.

In Comparative Examples 5 and 7 in which the back surface of the base was brought into contact with the adhesive roll and thereby cleaned, the spot-shaped unevenness number was 6 and 7 per 1 m², respectively. If the number of defects from spot-shaped unevenness is 6 per 1 m², the defect ratio is about 4% when the optical film is used in an image display device having a screen size of 5 inches (about 140 pieces per 1 m²). However, the defect ratio reaches about 20% when the screen size is 11 inches, and the defect ratio increases to almost 100% when the screen size is 20 inches or more. Therefore, it is apparent that in the case of cleaning with an adhesive roll, the rate of defects from spot-shaped unevenness is high and it is very difficult to obtain pieces of an optical film with good quality when the optical film is used for formation of a large image display device.

In contrast, it is apparent that when the back surface of the base is wet-cleaned by bringing the roll and the base into contact with each other with a cleaning liquid interposed therebetween as in Examples 1 to 4, a high-quality optical film, which has almost no spot-shaped unevenness and can be suitably used for formation of a large mage display device, is obtained.

1. A method for manufacturing an optical film, comprising:
unwinding a long-hand shaped flexible base having a first principal surface and a second principal surface from a continuous roll, and continuously feeding the base to a downstream side;
cleaning the second principal surface of the base by applying a cleaning liquid between the second principal surface and a cleaning roll and by spreading the cleaning liquid over the base by the cleaning roll; and
forming an optical film by applying a resin solution onto the first principal surface and then drying the resin solution.

2. A method for manufacturing an optical film according to claim 1, wherein the cleaning roll has an asperity pattern on a surface thereof, and a projection portion of the asperity pattern extends in non-parallel to a circumferential direction of the cleaning roll.

3. A method for manufacturing an optical film according to claim 1, wherein the cleaning roll is a gravure roll or a Meyer bar roll.

4. A method for manufacturing an optical film according to claim 1, wherein the cleaning liquid is a liquid having a boiling point lower than that of a water.

5. A method for manufacturing an optical film according to claim 1, wherein the optical film is formed so as to have a thickness of 40 μm or less.
